(19) United States
(12) Patent Application Publication
(10) Pub. No.: US 2023/0347763 A1
(43) Pub. Date: Nov. 2, 2023

(54) INTEGRATION OF DIRECT CURRENT BOOST CHARGING IN A CHARGING MODULE FOR ELECTRIFIED VEHICLE HIGH VOLTAGE BATTERY SYSTEMS

(71) Applicant: FCA US LLC, Auburn Hills, MI (US)

(72) Inventor: Kaveh Razi Kamanaj Olia, Torino (IT)

(21) Appl. No.: 18/306,561

(22) Filed: Apr. 25, 2023

Related U.S. Application Data
(60) Provisional application No. 63/337,361, filed on May 2, 2022.

(51) Int. Cl. H02M 1/42; H02J 7/00; B60L 53/22

(52) U.S. Cl. CPC B60L 53/22; H02J 7/0063; H02M 1/42; B60L 2210/10; H02J 2207/20

(57) ABSTRACT

A direct current (DC) boost charging (DCBC) system for a high voltage (HV) battery system of an electrified vehicle includes a charging module including (i) an isolated DC-DC converter connected to the HV battery system, (ii) bypass switches connected to the HV battery system and in parallel with the DC-DC converter, and (iii) a power factor correction (PFC) module connected between (a) an input DC voltage and (b) the DC-DC converter and the bypass switches, and a controller configured to command the PFC module to boost the input DC voltage to a higher DC voltage appropriate for recharging the HV battery system, and command the bypass switches to temporarily close thereby bypassing the DC-DC converter for recharging the HV battery system using the higher DC voltage generated by the PFC module.

### CROSS-REFERENCE TO RELATED APPLICATION(S)

The present application claims the benefit of United States Provisional Application Number 63/337,361, filed on May 2, 2022. The disclosure of this application is incorporated herein by reference in its entirety.

### FIELD

The present application generally relates to electrified vehicles (EVs) and, more particularly, to the integration of direct current (DC) boost charging in a charging module for EV high voltage (HV) battery systems.

### BACKGROUND

Electrified vehicles (EVs) have powertrains including a high voltage (HV) battery system and one or more electric propulsion motors. The HV battery system is charged in one of two modes: alternating current (AC) on-board charging and direct current (DC) charging. AC on-board charging could, for example, utilize an inverter to convert AC power (e.g., wall power or AC power generated by a rotating mechanical system, such as an optional internal combustion engine or one or more of the electric propulsion motors) into DC power for recharging of the HV battery system. Most conventional DC charging stations (e.g., non-highway DC charging stations) are configured for directly recharging HV battery systems at ~400-500 Volts (V).

Today’s EVs are beginning to implement HV battery systems rated at much higher voltages, such as ~800 or 1200 V. This is particularly true for high performance electrified powertrains. Until higher rated DC charging stations are commonplace, this presents a problem. One conventional solution to this problem is additional hardware (also known as a DC boost charging module, or DCBCM), which utilizes an isolated (i.e., a standalone or dedicated) DC-DC converter to boost the ~400-500 V of a conventional/non-highway DC charging station to a higher voltage (e.g., ~800 V). This additional hardware increases EV costs, complexity, and weight/packaging. Accordingly, while these conventional EV charging systems do work for their intended purpose, there exists an opportunity for improvement in the relevant art.

### SUMMARY

According to one example aspect of the invention, a direct current (DC) boost charging (DCBC) system for a high voltage (HV) battery system of an electrified vehicle is presented. In one exemplary implementation, the DCBC system comprises a charging module comprising (i) an isolated DC-DC converter connected to the HV battery system, (ii) bypass switches connected to the HV battery system and in parallel with the DC-DC converter, and (iii) a power factor correction (PFC) module connected between (a) an input DC voltage and (b) the DC-DC converter and the bypass switches, and a controller configured to command the PFC module to boost the input DC voltage to a higher DC voltage appropriate for recharging the HV battery system, and command the bypass switches to temporarily close thereby bypassing the DC-DC converter for recharging the HV battery system using the higher DC voltage generated by the PFC module.

In some implementations, the HV battery system is rated at 800 volts (V) DC, the input DC voltage is approximately 400 V, and the higher DC voltage generated by the PFC module is approximately 800 V. In some implementations, the charging module is an existing on-board charging module (OBCM) or integrated dual charging module (IDCM) of the electrified vehicle. In some implementations, each of the bypass switches is one of (i) an electro-mechanical relay, (ii) a solid-state switch, and (iii) back-to-back power transistors.

In some implementations, the charging module further comprises (i) an electromagnetic interference (EMI) filter and switches connected between the input DC voltage and the PFC module, (ii) a pair of capacitors connected between (a) the PFC module and (b) the DC-DC converter and the bypass switches, and (iii) an HV DC EMI filter connected between (c) the HV battery system and (d) the DC-DC converter and the bypass switches. In some implementations, each of the bypass switches is one of (i) an electro-mechanical relay, (ii) a solid-state switch, and (iii) back-to-back power transistors.

In some implementations, the electrified vehicle is a battery electric vehicle (BEV) comprising one or more electric traction motors powered by the HV battery system. In some implementations, the electrified vehicle does not include a standalone or dedicated DC boost charger. In some implementations, the electrified vehicle does not include a power inverter module (PIM) configured as a DC-DC boost converter.

According to another example aspect of the invention, a method of integrating and utilizing DCBC into an existing charging module for a HV battery system of an electrified vehicle is presented. In one exemplary implementation, the method comprises providing the existing charging module comprising a PFC module connected to an input DC voltage and a DC-DC converter connected to the HV battery system, obtaining a DCBC integrated charging module by modifying the existing charging module by isolating the DC-DC converter and adding bypass switches connected to the PFC module and the HV battery system in parallel with the isolated DC-DC converter, and utilizing the DCBC integrated charging module by (i) commanding, by a controller of the electrified vehicle, the PFC module to boost the input DC voltage to a higher DC voltage appropriate for recharging the HV battery system, and (ii) commanding, by the controller, the bypass switches to temporarily close thereby bypassing the DC-DC converter for recharging the HV battery system using the higher DC voltage generated by the PFC module.

In some implementations, the HV battery system is rated at 800 volts (V) DC, the input DC voltage is approximately 400 V, and the higher DC voltage generated by the PFC module is approximately 800 V. In some implementations, the existing charging module is an existing OBCM or IDCM of the electrified vehicle. In some implementations, each of the bypass switches is one of (i) an electro-mechanical relay, (ii) a solid-state switch, and (iii) back-to-back power transistors.

In some implementations, the DCBC integrated charging module further comprises (i) an electromagnetic interference (EMI) filter and switches connected between the input DC voltage and the PFC module, (ii) a pair of capacitors connected between (a) the PFC module and (b) the DC-DC converter and the bypass switches, and (iii) an HV DC EMI filter connected between (c) the HV battery system and (d) the DC-DC converter and the bypass switches. In some implementations, each of the bypass switches is one of (i) an electro-mechanical relay, (ii) a solid-state switch, and (iii) back-to-back power transistors.

In some implementations, the electrified vehicle is a BEV comprising one or more electric traction motors powered by the HV battery system. In some implementations, the electrified vehicle does not include a standalone or dedicated DC boost charger. In some implementations, the electrified vehicle does not include a PIM configured as a DC-DC boost converter.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example integrated direct current (DC) boost charging (DCBC) system according to the principles of the present application;

FIG. 2 is a combination block and circuit diagram of an example circuit architecture of the integrated DCBC system of FIG. 1 according to the principles of the present application; and

FIG. 3 is a flow diagram of an example DCBC integration and control method for a high voltage (HV) battery system of an electrified vehicle according to the principles of the present application.

### DESCRIPTION

As previously discussed, conventional electrified vehicle (EV) charging systems/methods suffer from additional required hardware to perform direct current (DC) charging of high voltage (HV) battery systems rated at higher voltages (e.g., 800 or 1200 Volts, or V) while utilizing conventional DC charging stations rated at lesser voltages (e.g., ~400-500 V). This additional hardware includes, for example, a separate dedicated/standalone DC boost controller (DCBC) module and corresponding low voltage (LV) and HV wiring harnesses. This additional hardware increases EV costs, complexity, and weight/packaging. Other conventional solutions include the implementation of multiple HV battery systems (e.g., ~400 V each) connectable in series and that are separately chargeable by conventional DC charging stations or to reconfigure an existing power inverter module (PIM) to operate as a DC-DC boost converter. Both of these solutions, however, suffer from the same issues of increased costs, complexity, and/or weight/packaging. The second solution relating to the PIM, in addition, would require a redesign of the electric motor(s) and the PIM itself.

Accordingly, improved charging systems and methods for EVS having HV battery systems are presented herein. This invention integrates a DCBC into an EV’s existing on-board charging module (OBCM) or integrated dual charging module (IDCM). This enables the usage of the same power electronics (input/output electromagnetic interference (EMI) filters, boost topology, power metal-oxide semiconductor field effect transistors (MOSFETs), boost inductors/capacitors, etc.) and controller configurations (microcontroller/digital signal processor (DSP), current/voltage/ temperature sensors, protection circuits, etc.). This is generally achieved by using the OBCM’s power factor correction (PFC) boost converter (a first stage) as a DC voltage booster and bypassing the OBCM’s second stage DC-DC converter via two (or four, e.g., for additional safety reasons) bypass switches, on both the positive and negative buses/rails, which are relatively simple and inexpensive devices. By integrating the DCBC functionality into the EV’s existing hardware, there is the potential for significant cost, complexity, and weight/packaging savings for the EV.

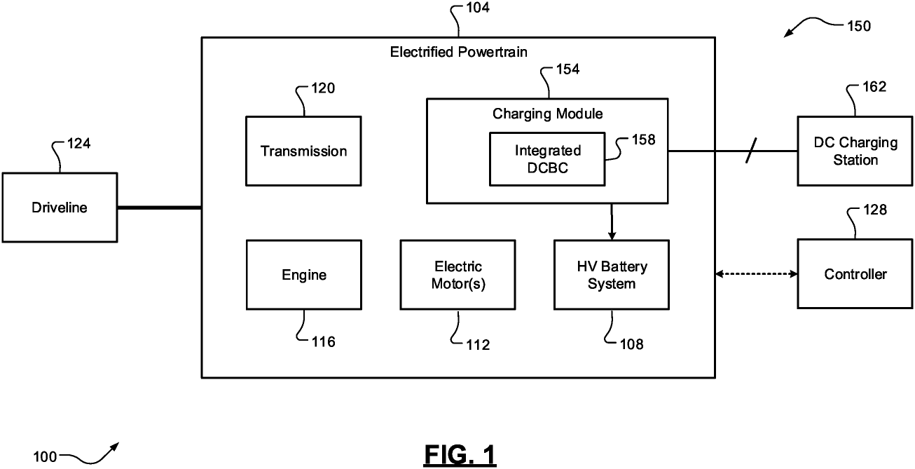

Referring now to FIG. 1, a functional block diagram of an electrified vehicle (EV) 100 having an example integrated DCBC module or system 150 according to the principles of the present application is illustrated. The EV 100 has an electrified powertrain 104 configured to generate drive torque for vehicle propulsion. The powertrain 104 generally comprises an HV battery system 108, one or more electric propulsion motors 112, an optional internal combustion engine 116, and a transmission 120 for transferring the drive torque to a driveline 124 of the EV 100. A controller 128 controls the operation of the EV 100 and, more specifically, the electrified powertrain 104 such that and the electrified powertrain 104 satisfies an operator or driver torque request (e.g., provided via an accelerator pedal, not shown). It will be appreciated that the electrified powertrain 104 could have any suitable configuration (series, parallel, etc.) provided that the HV battery system 108 is rated at a high enough voltage (e.g., 800 V or 1200 V) such that an integrated DCBC module/system 150 according to the principles of the present application is applicable. The integrated DCBC system 150 generally comprises a modified OBCM/IDCM 154 having an integrated DCBC module/system or charging module 158 and is configured to receive DC charging power from an external DC charging station 162, such as a roadside fast DC charging station.

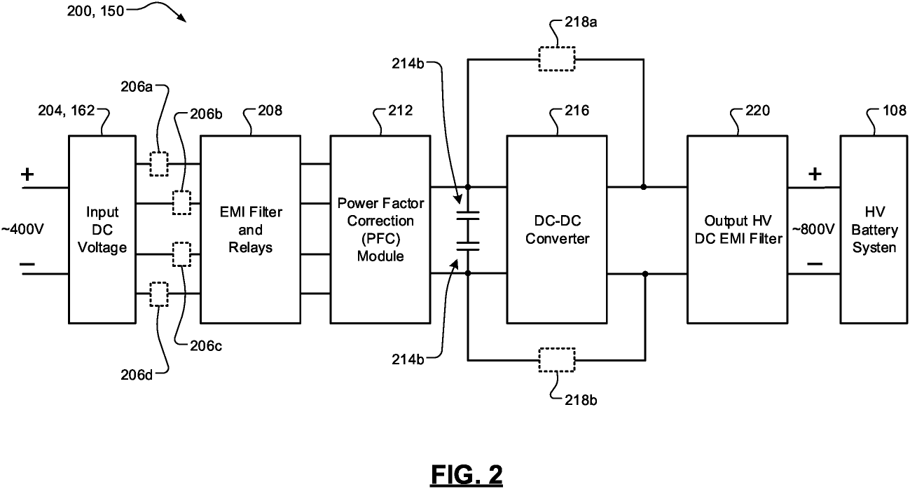

Referring now to FIG. 2 and with continued reference to FIG. 1, a combination block and circuit diagram of an example architecture or system 200 of the integrated DCBC system 150 of FIG. 1 is illustrated. The system 200 is generally configured for both alternating current (AC) on-board and DC charging and comprises a DC input voltage 204 (e.g., external DC charging station 162) connected to a bi-directional PFC module 212 via an EMI filter and relays 208. As previously mentioned, the external DC charging station 162 could include an inverter that converts wall outlet power to a DC voltage for charging purposes. The input terminals of the input DC voltage 204 could have a voltage differential of ~400-500 V DC and could each be rated at 80 amps (A) or optionally 96 A. The output terminals of the input DC voltage 204 and the input terminals of the EMI filter and relays 208 (also referred to as lines L1-L3 206a-206c and neutral N 206d, respectively) could each be rated at 40 A or optionally 48 A. In a first power conversion stage (“PFC boost”), the bi-directional PFC module 212 is configured to boost the input voltage of ~400 V DC and an input power (e.g., ~22 kilowatts, or kW) to a boosted output voltage of ~800 V DC and a boosted output power (e.g., ~48 kW) while maintaining the power factor close to one at the input side. The system 200 is controllable by the controller 128 of the electrified vehicle 100 or by a separate/standalone controller (not shown) for the system 200.

In a subsequent second power conversion stage, an isolated DC-DC converter module 216 is arranged between the bi-directional PFC module 212 and a final output HV DC EMI filter 220 for output voltage stabilization before being finally provided to the HV battery system 108 for recharging purposes. Capacitors 214a, 214b and bypass switches 218a, 218b are arranged in parallel therewith to adapt the PFC output voltage with the HV battery system voltage (e.g., ~800V) to support wide voltage range in the output while establishing galvanic isolation between the input (e.g., an AC power grid) and the HV battery system 108 as well. It will be appreciated that the terms “switch” and “relay” and “bypass switch” and “bypass relay” as used herein to generally refer to any device that provides for selective conduction of current therethrough and interruption of the current flow when desired. Examples of the “switches” include, but are not limited to, an electro-mechanical relay, (ii) a solid-state switch, and (iii) back-to-back power transistors (power MOSFETs, insulated gate bipolar transistors (IGBTs), etc.). As mentioned, the final output HV DC EMI filter 220 has DC output terminals that are connectable to the HV battery system for appropriate charging thereof. To briefly summarize, the key aspect to achieve DC boost charging from an existing charging module (e.g., OBCM or IDCM) is to use the first stage PFC module 212 as a DC boost and then bypass the second stage DC-DC converter 216 by two additional power relays 218a, 218b (both positive and negative rails). As shown, it is possible to reach 40 kW and up to ~48 kW DCBC by integration into an existing ~22 kW charging module (e.g., OBCM or IDCM).

As briefly mentioned above, it will be appreciated that the specific topology of the integrated DCBC system 150 of FIGS. 1 and 2 is easily variable and thereby adaptable to a plurality of different markets having differing AC power grid capabilities, including North American Free Trade Agreement (NAFTA) markets, respectively, e.g., up to ~40 kW DCBC, and Europe/Middle East/Asia (EMEA) and China markets, e.g., up to ~48 kW DCBC. For NAFTA markets, for example, AC charging mode could be single phase 120V/16A (1.9 kW) or 240V/80A (19.2 kW), AC discharging mode could be split-phase 120V/40A (4.8 kW per 120V circuit) and 240V/40A (9.6 kW) or optionally split-phase 120V/48A (5.75 kW per each 120V circuit) and 240V/48A (11.5 kW), and DC boost charging mode could be 80 ADC up to 40 kW or optionally 96 ADC up to 48 kW. For EMEA markets, for example, AC charging mode could be single phase 230V/32A (7.4 kW) or three-phase 400V/32A (22kW), AC discharging mode could be single phase 230V/32A (7.4 kW) or three-phase 400V/32A (22 kW), and DC boost charging mode could be 80 ADC up to 40 kW. For China markets, for example, AC charging mode could be single phase 220V/48A (10.5 kW) or three-phase 380V/32A (21 kW), AC discharging mode could be single phase 220V/32A (7.0 kW) or three-phase 380V/32A (21 kW), and DC boost charging mode could be 96 ADC up to 48 kW. It will be appreciated that yet another specific PFC topology could be utilized for all (e.g., worldwide) applications (e.g., a DCBC integrated in a 22kW charging module for up to 48 kW charging.

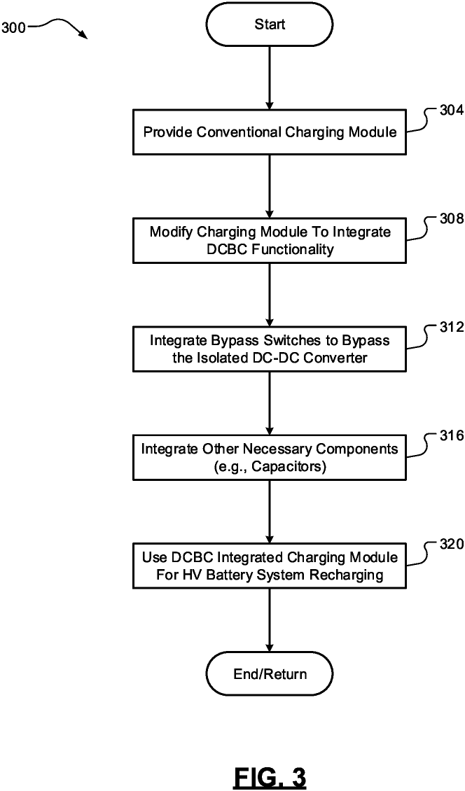

Referring now to FIG. 3, a flow diagram of an example integrated boost charging method 300 for an electrified vehicle according to the principles of the present application is illustrated. This method 300 is generally described as the modification or integration of a conventional charging module (e.g., OBCM or IDCM) to obtain a modified charging module according to the principles of the present application, but it will be appreciated that the present application also described control/operation methos thereof (i.e., operating the modified charging module to achieve higher voltage charging as described herein and its corresponding benefits). At 304, a conventional charging module is provided. At 308, the conventional charging module is modified by integrating a DCBC module 158 therein (see also 204 of FIG. 2). This includes, for example, bypass relays 218a, 218b at 312 and 316, respectively, into a second power conversion stage (after a first PFC boost conversion stage) around the existing isolated DC-DC converter module 216 of the conventional charging module. The result at 320 is obtaining a modified charging module 154 or 204 having an integrated DCBC 158 capable of charging a HV battery system (e.g., ~800 V) using a conventional DC charging station (e.g., ~400 V) or some suitable connection to wall outlet power and a corresponding AC power grid. The method 300 then ends or returns to 304.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A direct current (DC) boost charging (DCBC) system for a high voltage (HV) battery system of an electrified vehicle, the DCBC system comprising:
a charging module comprising:
(i) an isolated DC-DC converter connected to the HV battery system,
(ii) bypass switches connected to the HV battery system and in parallel with the DC-DC converter, and
(iii) a power factor correction (PFC) module connected between (a) an input DC voltage and (b) the DC-DC converter and the bypass switches; and
a controller configured to:
command the PFC module to boost the input DC voltage to a higher DC voltage appropriate for recharging the HV battery system; and
command the bypass switches to temporarily close thereby bypassing the DC-DC converter for recharging the HV battery system using the higher DC voltage generated by the PFC module.

2. The DCBC system of claim 1, wherein the HV battery system is rated at 800 volts (V) DC, the input DC voltage is approximately 400 V, and the higher DC voltage generated by the PFC module is approximately 800 V.

3. The DCBC system of claim 1, wherein the charging module is an existing on-board charging module (OBCM) or integrated dual charging module (IDCM) of the electrified vehicle.

4. The DCBC system of claim 1, wherein each of the bypass switches is one of (i) an electro-mechanical relay, (ii) a solid-state switch, and (iii) back-to-back power transistors.

5. The DCBC system of claim 1, wherein the charging module further comprises (i) an electromagnetic interference (EMI) filter and switches connected between the input DC voltage and the PFC module, (ii) a pair of capacitors connected between (a) the PFC module and (b) the DC-DC converter and the bypass switches, and (iii) an HV DC EMI filter connected between (c) the HV battery system and (d) the DC-DC converter and the bypass switches.

6. The DCBC system of claim 5, wherein each of the bypass switches is one of (i) an electro-mechanical relay, (ii) a solid-state switch, and (iii) back-to-back power transistors.

7. The DCBC system of claim 1, wherein the electrified vehicle is a battery electric vehicle (BEV) comprising one or more electric traction motors powered by the HV battery system.

8. The DCBC system of claim 1, wherein the electrified vehicle does not include a standalone or dedicated DC boost charger.

9. The DCBC system of claim 1, wherein the electrified vehicle does not include a power inverter module (PIM) configured as a DC-DC boost converter.

10. A method of integrating and utilizing direct current (DC) boost charging (DCBC) into an existing charging module for a high voltage (HV) battery system of an electrified vehicle, the method comprising:
providing the existing charging module comprising a power factor correction (PFC) module connected to an input DC voltage and a DC-DC converter connected to the HV battery system;
obtaining a DCBC integrated charging module by modifying the existing charging module by isolating the DC-DC converter and adding bypass switches connected to the PFC module and the HV battery system in parallel with the isolated DC-DC converter; and
utilizing the DCBC integrated charging module by (i) commanding, by a controller of the electrified vehicle, the PFC module to boost the input DC voltage to a higher DC voltage appropriate for recharging the HV battery system, and (ii) commanding, by the controller, the bypass switches to temporarily close thereby bypassing the DC-DC converter for recharging the HV battery system using the higher DC voltage generated by the PFC module.

11. The method of claim 10, wherein the HV battery system is rated at 800 volts (V) DC, the input DC voltage is approximately 400 V, and the higher DC voltage generated by the PFC module is approximately 800 V.

12. The method of claim 10, wherein the existing charging module is an existing on-board charging module (OBCM) or integrated dual charging module (IDCM) of the electrified vehicle.

13. The method of claim 10, wherein each of the bypass switches is one of (i) an electro-mechanical relay, (ii) a solid-state switch, and (iii) back-to-back power transistors.

14. The method of claim 10, wherein the DCBC integrated charging module further comprises (i) an electromagnetic interference (EMI) filter and switches connected between the input DC voltage and the PFC module, (ii) a pair of capacitors connected between (a) the PFC module and (b) the DC-DC converter and the bypass switches, and (iii) an HV DC EMI filter connected between (c) the HV battery system and (d) the DC-DC converter and the bypass switches.

15. The method of claim 14, wherein each of the bypass switches is one of (i) an electro-mechanical relay, (ii) a solid-state switch, and (iii) back-to-back power transistors.

16. The method of claim 10, wherein the electrified vehicle is a battery electric vehicle (BEV) comprising one or more electric traction motors powered by the HV battery system.

17. The method of claim 10, wherein the electrified vehicle does not include a standalone or dedicated DC boost charger.

18. The method of claim 10, wherein the electrified vehicle does not include a power inverter module (PIM) configured as a DC-DC boost converter.
